(19) United States
(12) Patent Application Publication
(10) Pub. No.: US 2017/0002943 A1
(43) Pub. Date: Jan. 5, 2017

(54) Burst Disk Assembly With a Burst Disk and an Actuator

(71) Applicant: Rembe GmbH Safety + Control, Brilon (DE)

(72) Inventors: Roland Bunse, Brilon (DE); Stefan Penno, Brilon (DE)

(21) Appl. No.: 15/200,440

(22) Filed: Jul. 1, 2016

(30) Foreign Application Priority Data
Jul. 2, 2015 (EP) 15 174 944.7

(51) Int. Cl. F16K 17/16

(52) U.S. Cl. CPC F16K 17/162

(57) ABSTRACT

The invention relates to a burst disk assembly with a single-part or multi-part body (1), which has an opening that forms an outlet for a conduit or a container, with a burst disk (2) that closes the opening and ruptures when subjected to burst pressure in order to unblock the opening, wherein the burst disk assembly has an actuator (3) with which the burst pressure can be reduced.

The present invention relates to a burst disk assembly having a single-part or multi-part body which has an opening capable of forming an outlet for a fluid conduit or a reservoir or another structure, with a burst disk that closes the opening and that ruptures when subjected to a defined pressure (nominal burst pressure) so as to unblock the opening.

Burst disk assemblies are often encountered in industrial plants to protect fluid conduits or containers of any kind against impermissible pressures and explosions. Burst disks produce in the conduits or containers or other structures predetermined breaking points at which the conduits or containers or other structures open in response to an increase of the pressure in the conduits or containers or other structures so that an uncontrolled rupture of the conduits or containers or other structures can be expected. The burst disks that open at a nominal burst pressure thus enable controlled venting or controlled pressure relief of the conduits or containers or the other structures.

Burst disk assemblies generally have a body that can be designed in many different ways. It can be produced monolithically or from multiple parts. The body may be part of the conduit or the container to be secured. The body has an opening forming an outlet of the conduit or the container to be secured, via which the pressure can be relieved in the event that the nominal burst pressure is reached, and the fluid stored in the conduit or in the container can escape. This opening is closed in normal operation by a burst disk which is for this purpose attached on the body.

The nominal burst pressure (also referred to as set pressure) of a burst disk depends on several characteristic properties of the burst disk. Above all, the external structure should be mentioned, for example, the geometric features of the burst disk (the thickness, length, and width or diameter of the burst disk, curvatures, indentations in the burst disk produced by material removal, etc.) or the employed material. Important factors are, in addition to the selected material, also the internal structure of the material, for example, the microstructure of the material which may be changed, for example, by local deformations, as described for example in the document DE 10 2007 022 018 A1. The nominal burst pressure can also be adjusted by way of buckling bars.

Burst disks have proven effective many times over in the past and have protected plants, animals and humans from major damage and disasters. Nevertheless, damage can occur also in the cases where a burst disk opens.

In some of these cases, it may be desirable when the burst disk opens at a pressure that is lower than the nominal burst pressure, for example half the nominal burst pressure. However, the burst disk is prevented from opening at a lower pressure in these situations, since pressures can be reached even during trouble-free operation of the conduit or the container which—to stay with the example—are higher than half the nominal burst pressure. Therefore, burst disks with a lower nominal burst pressure cannot be used in these situations.

It was therefore an object of the invention to design a burst disk assembly so that the burst disk can, if desired, also open at a lower burst pressure, while opening in each event when the nominal burst pressure is reached.

This object is attained with the invention in that the burst disk assembly has an actuator configured to reduce the burst pressure. The burst pressure of the burst disk may then be selectively reduced with the actuator such that the burst disk also opens at a pressure that is less than the nominal burst pressure. Thus, the conduit secured by the burst disk assembly or the container secured by the burst disk assembly or the structure secured by the burst disk assembly may thus be also relieved at a pressure that is lower than the nominal burst pressure. At the same time, the burst disk can, at least until the burst pressure is reduced, be operated at pressures that are higher than the pressure to which the burst pressure can be lowered by way of the actuator.

The burst pressure of the burst disk can be reduced irreversibly or reversibly. Reversible means that the burst pressure can optionally be increased again to the nominal burst pressure when it is no longer desirable to vent or relieve pressure at a pressure lower than the nominal burst pressure. Irreversible means that the burst pressure is lowered once and can thereafter not be increased again. If the burst pressure of burst disk assembly is to be increased again, then the burst disk assembly or at least the burst disk must be exchanged.

According to the invention, the burst disk assembly may be designed so that energy can be applied by the actuator to the burst disk in the form of impact forces. In particular, by applying energy in the form of impact forces, the behavior of the burst disk can be affected quickly and the nominal burst pressure can be affected. The applied energy may be kinetic, electrical and/or thermal energy. Kinetic energy may be transmitted to the burst disk, for example, by tensile or compressive forces.

Preferably, the burst pressure is lowered by the actuator without destroying the burst disk, because the burst disk can burst in response to the pressure in the conduit or in the container only when the burst disk remains intact. Destruction of the burst disk, for example by a mechanical perforation of the burst disk by the actuator, would result in a reduction of the burst pressure to zero, which is not beneficial in view of the object underlying the invention.

The burst disk may still be destroyed suddenly as a result of the reduction of the burst pressure by the actuator, namely when the conduit, the container or the structure has a pressure above the burst pressure, to which the actuator lowers the burst pressure. The burst disk then immediately responds to the reduction of the burst pressure by the actuator.

With the actuator of a burst disk assembly according to the invention, the internal structure of the material from which the burst disk is constructed, and/or the geometry of the burst disk, in particular the shape of the burst disk, can be changed reversibly or irreversibly at least at one location of the burst disk to lower the burst pressure. The location of the burst disk to which the change is applied may have for example a diameter of 2.7 mm for a burst disk with a diameter of 142 mm, a sheet metal thickness of 0.8 and a curvature with a depth of 23.5 mm.

The actuator of a burst disk assembly according to the invention may have a rod and a drive, wherein the rod may be driven by the drive to transmit energy to the burst disk when the drive is energized by applying an impact stroke to the rod or by applying tension to the rod.

The rod may have a first face which is spaced from the burst disk when the actuator is switched off and which makes contact with the burst disk when the actuator is switched on, in particular during the execution of the impact stroke. It is also possible that the first face of the rod makes contact with the burst disk when the actuator is switched off, whereas the first face of the rod is removed from the burst disk in the ON state, thereby changing the inner or the outer structure of the burst disk.

The drive may be an electric drive, although pneumatic or hydraulic actuators may also be used. The drive may include an electromagnet.

The force applied by a drive in the previously mentioned example of a burst disk with a diameter of 142 mm may reach 2300 N. Energy of 3.43 J may be introduced.

In a burst disk assembly according to the invention, the actuator may be arranged so that a location of the burst disk, which the rod strikes when the drive is switched on or on which the rod pulls when the drive switched on, is located between a center of the burst disk and an edge of the burst disk. The location may also correspond to the center. Tests have shown that in a circular reversible burst disk the burst pressure can be reduced the more, the more the location on which the rod acts, is located in the vicinity of the center. The reduction of the burst pressure may be determined in the test by choosing the location along a radius.

A burst disk assembly according to the invention may include a controller which has an output that is connected to a switching input of the drive and with which the actuator is controllable. Such controller may have at least one input for a sensor, wherein data read via the input can be processed by way of a control program of the controller. A result of the processing of the read data may be a switching signal which may be supplied to the actuator via the output of the controller and the switching input of the actuator in order to turn on the actuator.

The burst disk used in a burst disk assembly according to the invention may be a reversible burst disk. Basically, any type of burst disk of any shape may be used in a burst disk assembly according to the invention, for example, tensile-stressed burst disks, reversible burst disks, buckling pin reversible burst disks, flat burst disks, etc.

Further features and advantages of the present invention will become apparent from the following description of preferred exemplary embodiments with reference to the accompanying drawings, which show in:

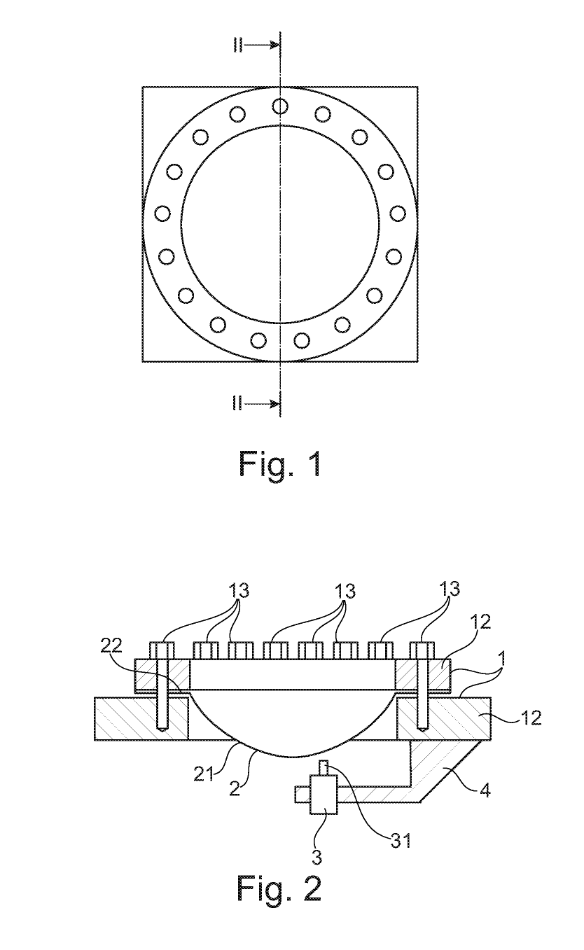

FIG. 1 a schematic diagram of a burst disk assembly according to the invention from above, and

FIG. 2 a schematic diagram of the burst disk assembly according to the invention from the side.

The burst disk assembly schematically illustrated in FIGS. 1 and 2 has a multi-part body 1. This body includes as the first part a plate 12 having an opening. The plate may be part of a wall, a conduit or a container. The opening of the plate 12 is closed off by a reversible burst disk. 2 The burst disk 2 is attached to the plate 11 by way of a ring 12 which forms a second part of the body 1, and with screws 13. For this purpose, the screws pass through the ring 12 and an edge 22 of the burst disk 2 and are screwed into threaded holes in the plate. The burst disk may also be mounted between the plate and the ring by way of clamping, or in another way.

The reversible burst disk is curved toward the inside of the container or conduit in order to protect the same from an overpressure. When the vessel is to be protected from a vacuum, the reversible burst disk would have to be mounted in the opposite direction. The burst disk 2 may be designed in a conventional manner. In particular, the burst disk may have two grooves or slots along which the burst disk 2 ruptures.

To this point, the burst disk is designed like a conventional burst disk.

The burst disk assembly according to the invention also includes an actuator 3, which is attached to the plate by way of a support arm 4. The support arm 4 projects from the edge of the burst disk 2 toward the center of the burst disk 2. A recess, in which the actuator 3 is inserted, is provided at the end of the arm 4.

The actuator 3 has an electromagnet with a winding in which a rod 31 is mounted for linear displacement. A force which linearly displaces the rod can be generated by switching on a current. The displacement takes place abruptly.

When the actuator 3 is de-energized, i.e. without current flow through the winding of the actuator 3, the rod 31 of the actuator 3 projects at a right angle or approximately at a right angle in the direction of the burst disk 2 and terminates with a gap from the burst disk 2. The end face of the rod 31 facing the burst disk 2 is a first face with which the rod 31 strikes against the burst disk when the actuator 3 is switched on.

The first face may be flat or concave or convex.

At least the internal structure of the burst disk 2 is changed by the impact at a location where the actuator 3 may strike the burst disk 2. In addition, a small bump may be formed in the burst disk. This change causes a reduction of the burst pressure of the burst disk 2. This means that the nominal burst pressure of the burst disk 2 can be changed, namely reduced, by the actuator 3, thus potentially causing the burst disk to respond, namely flip and rupture, in the interim at a lower pressure so as to unblock the opening in the body 1 and to achieve an early pressure relief of the protected container or the protected conduit compared to the nominal burst pressure.

1. A burst disk assembly comprising:
at least a single-part body (1), having an opening that forms an outlet for a conduit, with a burst disk (2) that closes the opening and ruptures the opening when subjected to a burst pressure
wherein
the burst disk is combined with an actuator (3) configured to reduce the burst pressure.

2. The burst disk assembly according to claim 1, wherein the actuator (3) provides energy for abruptly applying to the burst disk (2) in impulse-form.

3. The burst disk assembly according to claim 2, wherein the energy is kinetic, electrical, and/or thermal energy.

4. The burst disk assembly according to claim 1, wherein the burst pressure is reduceable without of destroying the burst disk (2).

5. The burst disk assembly according to claim 1, wherein for reducing the burst pressure, the internal or external structure of the material of which the burst disk (2) is made and/or the geometry of the burst disk (2) is reversibly or irreversibly changed at least at one location of the burst disk (2).

6. The burst disk assembly according to claim 1, wherein the actuator (3) comprises a rod (31) and a drive, wherein the rod (31) is driven by the drive to transfer energy to the burst disk (2) by an impact force to or by tension on the rod (31) when the drive is switched on.

7. The burst disk assembly according to claim 6, wherein the rod (31) has a first face which in the switched-off state of the actuator is arranged with a spacing from the burst disk (2) and which contacts the burst disk (2) in the switched-on state, or vice versa.

8. The burst disk assembly according to claim 7, wherein the drive is an electric drive.

9. The burst disk assembly according to claim 8, wherein the drive comprises an electromagnet.

10. The burst disk assembly according to claim 1, wherein the actuator (3) is arranged so that a location of the burst disk (3), on which the rod (31) acts when the drive is switched on, corresponds to the center or is located between a center of the burst disk (2) and an edge (22) of the burst disk.

11. The burst disk assembly according claim 1, wherein the burst disk assembly comprises a controller having an output that is connected to a switching input of the actuator (3) providing controllability to the actuator (3).

12. The burst disk assembly according to claim 11, wherein the controller has at least one input for a sensor, wherein data read via the input can be processed with a control program of controller.

13. The burst disk assembly according to claim 12, wherein a result of the processing of the read data is a switching signal, which is supplied to the actuator (3) via the output of the controller and the switching input of the actuator (3) in order to switch the actuator (3) on.

14. The burst disk assembly according to claim 1, wherein the burst disk (2) is a reversible burst disk or a tensile-stressed burst disk.

15. A method for reducing the burst pressure of a burst disk (2), comprising the steps of:
providing an actuator (3) driven manually to act,
before the burst disk (2) reaches a nominal burst pressure, on the burst disk in order to reduce the burst pressure of the burst disk (2).

16. The burst disk assembly according to claim 1, wherein the single part body comprises multiple parts.
